(19) United States
(12) Patent Application Publication
(10) Pub. No.: US 2016/0278606 A1
(43) Pub. Date: Sep. 29, 2016

(54) DISHWASHER APPLIANCE AND A METHOD FOR FORMING A UNITARY SPRAY ARM FOR A DISHWASHER APPLIANCE

(71) Applicant: General Electric Company, Schenectady, NY (US)

(72) Inventors: Gregory Owen Miller, Louisville, KY (US); John Edward Dries, Louisville, KY (US)

(21) Appl. No.: 14/664,977

(22) Filed: Mar. 23, 2015

(51) Int. Cl. A47L 15/42; B08B 3/02

(52) U.S. Cl. CPC A47L 15/428; B08B 3/024; B33Y 10/00

(57) ABSTRACT

A dishwasher appliance includes a spray assembly with a unitary spray arm. The unitary spray arm of the spray assembly defines a plurality of outlets. The unitary spray arm of the spray assembly also defines a plurality of channels within the unitary spray arm. Each channel of the plurality of channels extends to at least one of the plurality of outlets. A first channel of the plurality of channels has a first cross-sectional area, and a second channel of the plurality of channels has a second, different cross-sectional area. A related method for forming a unitary spray arm for a dishwasher appliance is also provided.

### FIELD OF THE INVENTION

The present subject matter relates generally to dishwasher appliances and spray arms for dishwasher appliances.

### BACKGROUND OF THE INVENTION

Dishwasher appliances generally include a tub that defines a wash chamber. A user may load articles into the wash chamber and activate the dishwasher appliance in order to clean the articles. Certain dishwasher appliances include spray arms that direct wash fluid sprays onto articles within the wash chamber. The spray arms generally rotate during operation of the dishwasher appliance. By rotating, distribution of wash fluid spray from the spray arms can be improved.

However, even with rotation of the spray arms, applying wash fluid in a uniform manner onto all articles within the wash chamber can be difficult. For example, articles positioned at corners of the wash chamber can be difficult to clean with wash fluid from the spray arms. In particular, directing wash fluid from a rotating spray arm into cups or bowls positioned at corners of the wash chamber can be difficult. As another example, rack assemblies within the wash chamber are generally arranged for a particular distribution of article types. In particular, a middle portion of an upper rack may be designed for supporting bowls and other shallow vessels while an outer portion of the upper rack may be designed for supporting cups, glasses and other deep vessels. In such upper racks, applying equal volumes of wash fluid to the middle and outer portions of the upper rack may be inefficient because shallow vessels can require less fluid to clean relative to deep vessels.

Accordingly, a dishwasher appliance with features for improving cleaning of articles within the dishwasher appliance would be useful. In particular, a spray arm for a dishwasher appliance that includes features for applying wash fluid onto articles within the dishwasher appliance in a desired spray pattern would be useful.

### BRIEF DESCRIPTION OF THE INVENTION

The present subject matter provides a dishwasher appliance. The dishwasher appliance includes a spray assembly with a unitary spray arm. The unitary spray arm of the spray assembly defines a plurality of outlets. The unitary spray arm of the spray assembly also defines a plurality of channels within the unitary spray arm. Each channel of the plurality of channels extends to at least one of the plurality of outlets. A first channel of the plurality of channels has a first cross-sectional area, and a second channel of the plurality of channels has a second, different cross-sectional area. A related method for forming a unitary spray arm for a dishwasher appliance is also provided. Additional aspects and advantages of the invention will be set forth in part in the following description, or may be apparent from the description, or may be learned through practice of the invention.

In a first exemplary embodiment, a dishwasher appliance is provided. The dishwasher appliance includes a tub that defines a wash chamber. A rack assembly is disposed within the wash chamber of the tub. The rack assembly is configured for supporting articles for washing within the wash chamber of the tub. A spray assembly with a unitary spray arm is positioned within the wash chamber of the tub. The unitary spray arm of the spray assembly is configured for rotation about a central axis of the spray assembly. The unitary spray arm of the spray assembly defines a plurality of outlets. At least one outlet of the plurality of outlets is positioned adjacent an end portion of the unitary spray arm. The unitary spray arm of the spray assembly also defines a plurality of channels within the unitary spray arm. Each channel of the plurality of channels extends to at least one of the plurality of outlets in order to direct wash fluid to at least one of the plurality of outlets. A first channel of the plurality of channels has a first cross-sectional area. A second channel of the plurality of channels has a second cross-sectional area. The first cross-sectional area is different than the second cross-sectional area.

In a second exemplary embodiment, a method for forming a unitary spray arm for a dishwasher appliance is provided. The method includes establishing three-dimensional information of the unitary spray arm and converting the three-dimensional information of the unitary spray arm from the step of establishing into a plurality of slices. Each slice of the plurality of slices defines a respective cross-sectional layer of the unitary spray arm. The method also includes successively forming each cross-sectional layer of the unitary spray arm with an additive process. After the step of successively forming, the unitary spray arm: (1) defines a plurality of outlets with at least one outlet of the plurality of outlets positioned adjacent an end portion of the unitary spray arm; (2) defines a plurality of channels within the unitary spray arm with each channel of the plurality of channels extending to at least one of the plurality of outlets, a first channel of the plurality of channels having a first cross-sectional area, a second channel of the plurality of channels having a second cross-sectional area, and the first cross-sectional area being different than the second cross-sectional area.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwasher appliance according to an exemplary embodiment of the present subject matter.

FIG. 2 provides a partial side section view of the exemplary dishwasher appliance of FIG. 1.

FIG. 3 provides a top, plan view of a unitary spray arm according to an exemplary embodiment of the present subject matter.

FIG. 4 provides a partial, elevation view of the exemplary spray arm of FIG. 3.

FIG. 5 provides a section view of the exemplary spray arm of FIG. 4 taken along the 5-5 line of FIG. 4.

FIG. 6 illustrates a method for forming a unitary spray arm according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

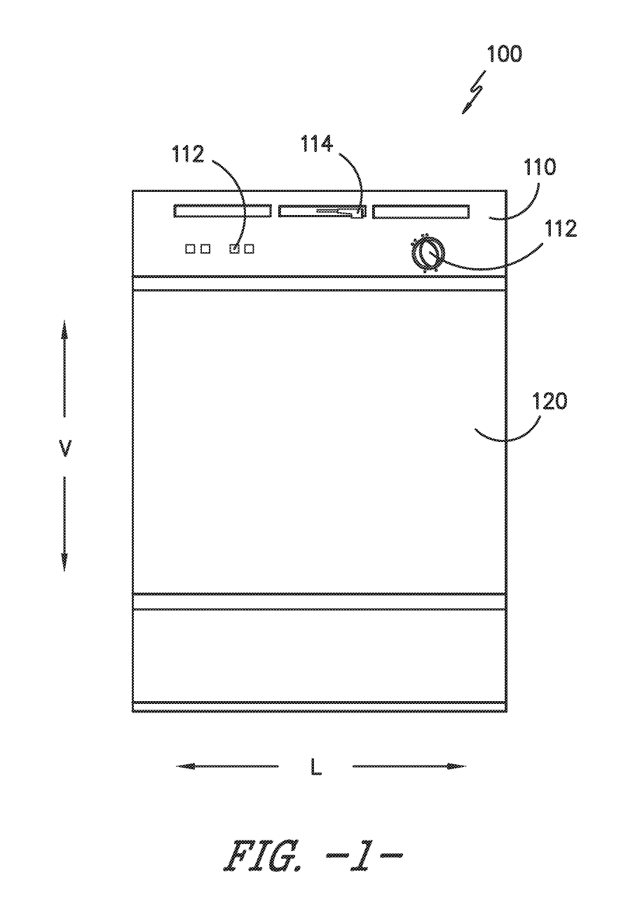

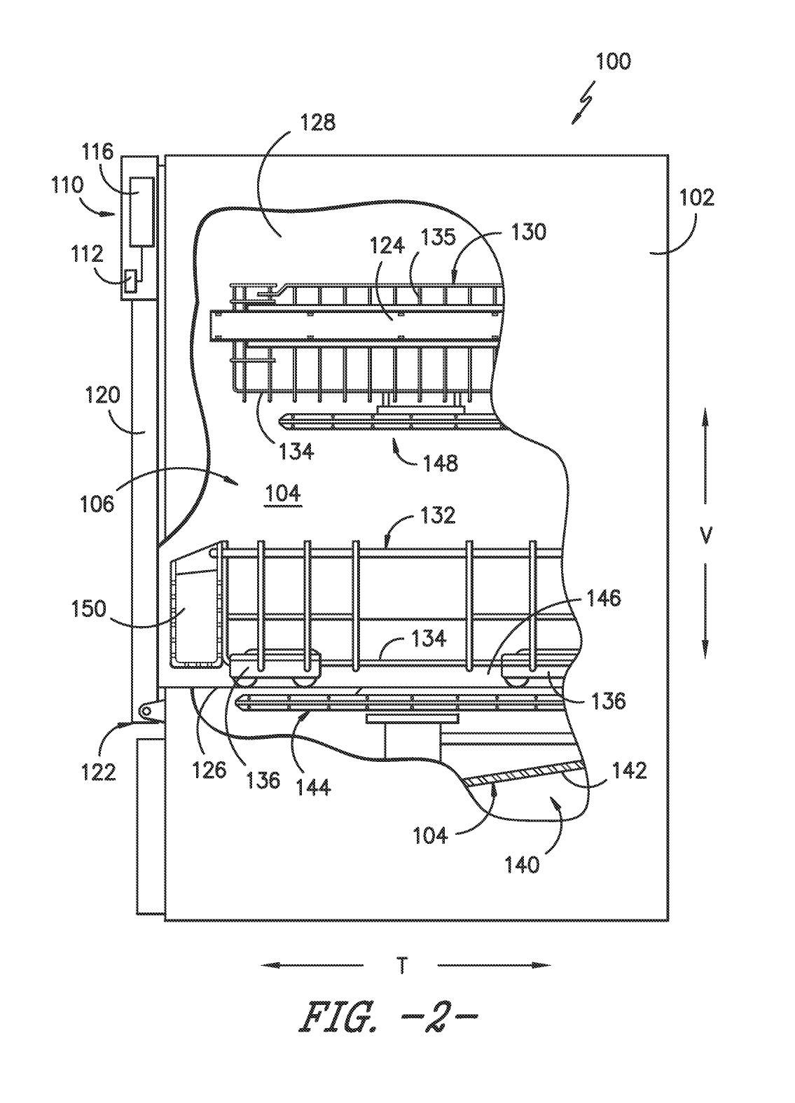

FIGS. 1 and 2 depict a dishwasher appliance 100 according to an exemplary embodiment of the present subject matter. Dishwasher appliance 100 defines a vertical direction V, a lateral direction L (FIG. 1) and a transverse direction T (FIG. 2). The vertical, lateral, and transverse directions V, L, and T are mutually perpendicular and form an orthogonal direction system.

Dishwasher appliance 100 includes a chassis or cabinet 102 having a tub 104. Tub 104 defines a wash chamber 106 and includes a front opening (not shown) and a door 120 hinged at its bottom 122 for movement between a normally closed vertical position (shown in FIGS. 1 and 2), wherein wash chamber 106 is sealed shut for washing operation, and a horizontal open position for loading and unloading of articles from dishwasher appliance 100. A latch 114 is used to lock and unlock door 120 for access to chamber 106.

Slide assemblies 124 are mounted on opposing tub sidewalls 128 to support and provide for movement of an upper rack assembly 130. Lower guides 126 are positioned in opposing manner of the sides of chamber 106 and provide a ridge or shelf for roller assemblies 136 so as to support and provide for movement of a lower rack assembly 132. Each of the upper and lower rack assemblies 130 and 132 is fabricated into lattice structures including a plurality of elongated members 134 and 135 that extend in lateral (L), transverse (T), and/or vertical (V) directions. Each rack assembly 130, 132 is adapted for movement between an extended loading position (not shown) in which the rack is substantially positioned outside the wash chamber 106, and a retracted position (shown in FIGS. 1 and 2) in which the rack is located inside the wash chamber 106. This is facilitated by slide assemblies 124 and roller assemblies 136 that carry the upper and lower rack assemblies 130 and 132, respectively. A silverware basket 150 may be removably attached to the lower rack assembly 132 for placement of silverware, small utensils, and the like, that are too small to be accommodated by the upper and lower rack assemblies 130, 132.

Dishwasher appliance 100 also includes a lower spray assembly 144 that is rotatably mounted within a lower region 146 of the wash chamber 106 and above a tub sump portion 142 so as to rotate in relatively close proximity to lower rack assembly 132. A spray arm or mid-level spray assembly 148 is located in an upper region of the wash chamber 106 and may be located in close proximity to upper rack assembly 130. Additionally, an upper spray assembly (not shown) may be located above the upper rack assembly 130 and mounted to an upper wall of tub 104.

Lower and mid-level spray assemblies 144, 148 and the upper spray assembly are fed by a fluid circulation assembly for circulating water and wash fluid in the tub 104. Portions of the fluid circulation assembly may be located in a machinery compartment 140 located below tub sump portion 142 of tub 104, as generally recognized in the art. Each spray assembly includes an arrangement of discharge ports or orifices for directing washing liquid onto dishes or other articles located in upper and lower rack assemblies 130, 132, respectively. The arrangement of the discharge ports in at least the lower spray assembly 144 provides a rotational force by virtue of washing fluid flowing through the discharge ports. The resultant rotation of lower spray assembly 144 provides coverage of dishes and other articles with a washing spray.

Dishwasher appliance 100 is further equipped with a controller 116 to regulate operation of dishwasher appliance 100. Controller 116 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 116 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 116 may be positioned in a variety of locations throughout dishwasher appliance 100. In the illustrated embodiment, controller 116 may be located within a control panel area 110 of door 120 as shown. In such an embodiment, input/output (“I/O”) signals may be routed between the control system and various operational components of dishwasher appliance 100 along wiring harnesses that may be routed through bottom 122 of door 120. Typically, the controller 116 includes a user interface panel 112 through which a user may select various operational features and modes and monitor progress of the dishwasher appliance 100. In one embodiment, user interface panel 112 may represent a general purpose I/O (“GPIO”) device or functional block. In one embodiment, the user interface panel 112 may include input components, such as one or more of a variety of electrical, mechanical or electro-mechanical input devices including rotary dials, push buttons, and touch pads. User interface panel 112 may include a display component, such as a digital or analog display device designed to provide operational feedback to a user. User interface panel 112 may be in communication with controller 116 via one or more signal lines or shared communication busses.

It should be appreciated that the present subject matter is not limited to any particular style, model, or configuration of dishwasher appliance. Thus, the exemplary embodiment depicted in FIGS. 1 and 2 is provided for illustrative purposes only. For example, different locations may be provided for a user interface 112, different configurations may be provided for upper and lower rack assemblies 130, 132 and/or lower and mid-level spray assemblies 144, 148, and other differences may be applied as well.

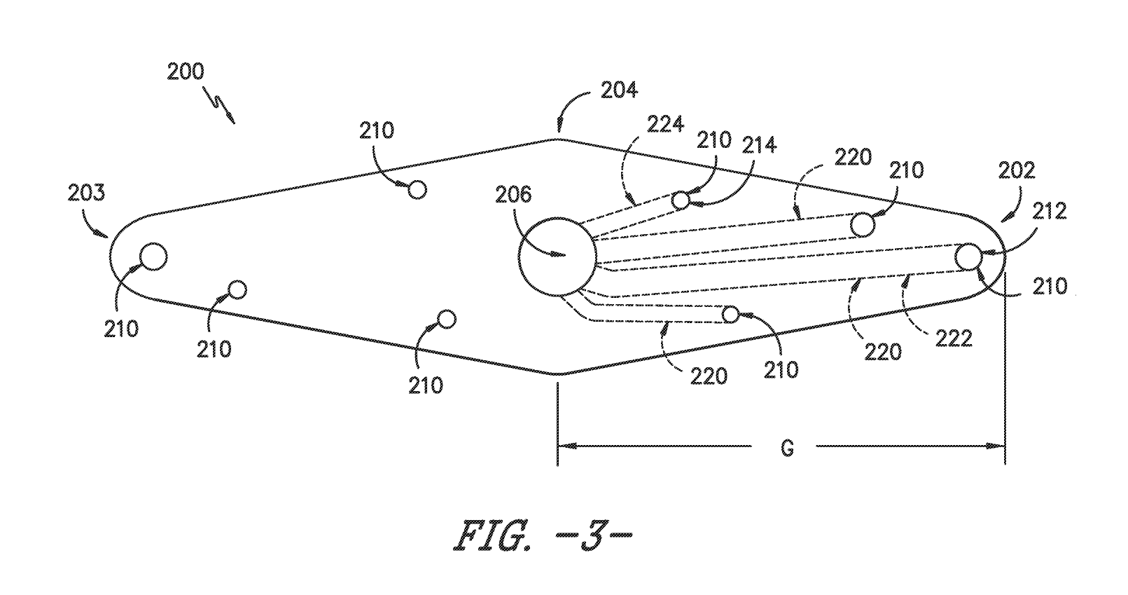

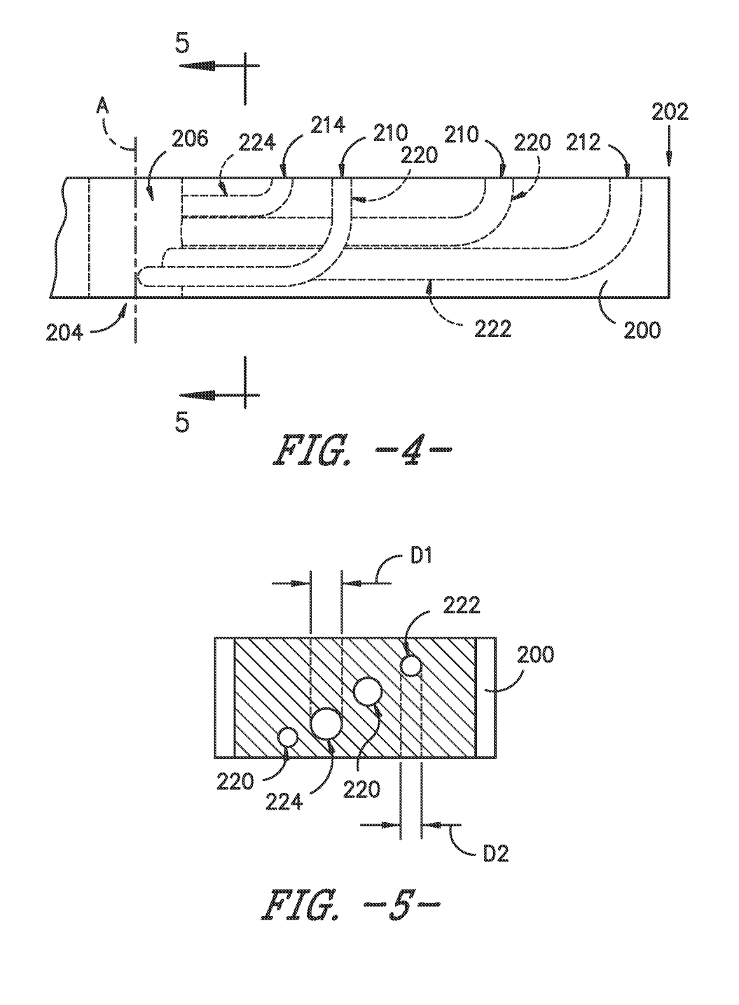

FIG. 3 provides a top, plan view of a unitary spray arm 200 according to an exemplary embodiment of the present subject matter. FIG. 4 provides a partial, elevation view of spray arm 200. As used herein, the term “unitary” may mean that spray arm 200 is constructed of a single, continuous piece of material. For example, spray arm 200 may be integrally formed of a single, continuous piece of plastic, e.g., as discussed in greater detail below.

Spray arm 200 may be used in any suitable dishwasher appliance. For example, spray arm 200 may be used in dishwasher appliance 100 (FIG. 1) as one of lower spray assembly 144 and mid-level spray assembly 148. Spray arm 200 is configured for rotation about a central axis A of spray arm 200, e.g., during operation of an associated dishwasher appliance. Thus, spray arm 200 may spin about the central axis A at a hub or central portion 204 of spray arm 200, e.g., in order to improve distribution of wash fluid within wash chamber 106 of dishwasher appliance 100.

Spray arm 200 defines a plurality of outlets 210. Outlets 210 are configured for directing respective flows of wash fluid out of spray arm 200. Spray arm 200 may define any suitable number of outlets 210. For example, spray arm 200 may define at least four outlets 210, at least eight outlets 210, at least twelve outlets 210, etc., e.g., on each side of spray arm 200. Outlets 210 may have any suitable distribution on spray arm 200. For example, at least one of outlets 210 may be positioned at or adjacent an end portion 202 of spray arm 200, and outlets 210 may be distributed or dispersed between end portion 202 of spray arm 200 and central portion 204 of spray arm 200. Thus, outlets 210 may be distributed along a length G of spray arm 200, e.g., between end portion 202 of spray arm 200 and central portion 204 of spray arm 200. As shown in FIG. 3, outlets 210 may also be positioned at and distributed along an opposite wing of spray arm 200, e.g., to another end portion 203 of spray arm 200 positioned opposite end portion 202 of spray arm 200.

Spray arm 200 also defines a plurality of channels 220 within spray arm 200. Each channel of channels 220 extends to a respective one (e.g., or at least one) of outlets 210. Thus, channels 220 direct respective flows of wash fluid to each outlet of outlets 210. As an example, each channel of channels 220 may extend from central portion 204 of spray arm 200 to the respective one of outlets 210. Thus, an inlet 206 (e.g., a single inlet) at central portion 204 of spray arm 200 may receive wash fluid, e.g., from a pump of dishwasher appliance 100, and channels 220 may direct such wash fluid to outlets 210. From outlets 210, the wash fluid may be sprayed onto articles within wash chamber 106 of dishwasher appliance 100. Channels 220 may be separate or spaced apart from one another within spray arm 200, e.g., such that channels 220 are not contiguous with one another within spray arm 200.

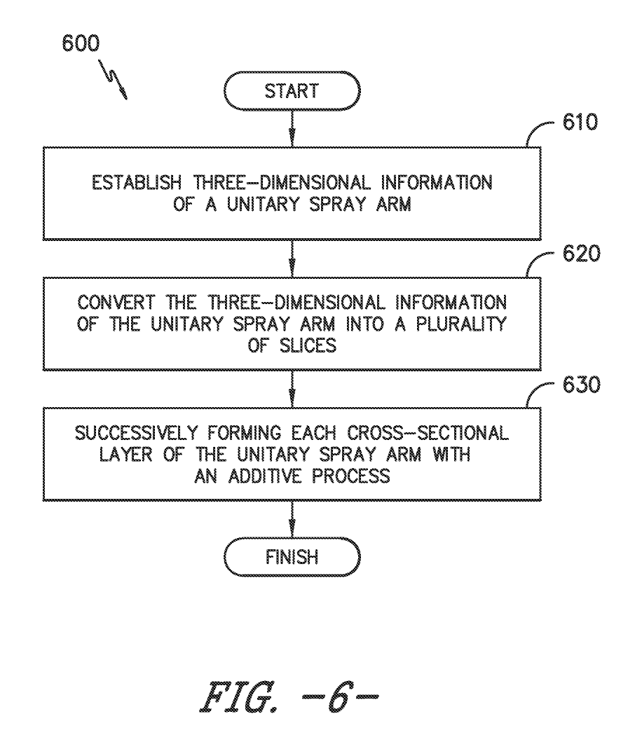

FIG. 5 provides a section view of spray arm 200 taken along the 5-5 line of FIG. 4. As may be seen in FIG. 5, channels 220 may have different or distinct cross-sectional areas or sizes. For example, a first channel 222 of channels 220 may have a first cross-sectional area and a second channel 224 of channels 220 may have a second cross-sectional area with the first and second cross-sectional areas being different. In particular, first and second channels 222, 224 have circular cross-sectional areas in the exemplary embodiment shown in FIG. 5. Thus, first channel 222 has a first diameter D1 and second channel 224 has a second diameter D2 with the first and second diameters D1, D2 being different, in the exemplary embodiment shown in FIG. 5. Each channel of channels 220 may have a different size and/or shape in certain exemplary embodiments, but it should be understood that various sets or groups of channels 220 may also have common sizes and/or shapes in certain exemplary embodiments.

Selecting suitable sizes for each channel of channels 220 may provide a desired spray pattern from spray arm 200. For example, first channel 222 may extend to a first outlet 212 of outlets 210, and a second channel 224 may extend to a second outlet 214 of outlets 210. First outlet 212 may be positioned closer to end portion 202 of spray arm 200 than second outlet 214, and first channel 222 may be bigger than second channel 224, e.g., the first cross-sectional area may be larger than the second cross-sectional area. In such a manner, more wash fluid may be supplied to first outlet 212 at end portion 202 of spray arm 200 than second outlet 214 that is positioned closer to central portion 204 of spray arm 200. Thus, if desired, more wash fluid may be applied to the outer portions of an associated rack assembly. It should be understood that any suitable alternative sizing and/or arrangement of channels 220 within spray arm 200 may be utilized in alternative exemplary embodiments to achieve a desired spray pattern. For example, the positions of first and second outlets 212, 214 on spray arm 200 may be flipped in alternative exemplary embodiments.

Channels 220 may have any suitable shape. For example, the cross-sectional area of channels 220 may vary along a length of channels 220, e.g., between central portion 204 of spray arm 200 and the respective outlet of outlets 210. Thus, the first diameter D1 of first channel 222 and/or the second diameter D2 of second channel 224 may vary (e.g., reduce and/or increase) along the length of first and second channels 222, 224, respectively. As another example the cross-sectional area of channels 220 may be uniform or constant along the length of channels 220, e.g., between central portion 204 of spray arm 200 and the respective outlet of outlets 210. Thus, the first diameter D1 of first channel 222 and/or the second diameter D2 of second channel 224 may be constant along the length of first and second channels 222, 224, respectively. In addition, outlets 210 may have an oval shape, a polygon shape, etc. in alternative exemplary embodiments. Turning, back to FIG. 3, a size of each outlet of outlets 210 may be proportional to or match the size of the respective channel of channels 220, in certain exemplary embodiments.

As discussed above, the sizing of channels 220 may provide a desired spray pattern from spray arm 200. Thus, when forming spray arm 200, the sizing of channels 220 may be selected to provide suitable wash spray flow from outlets 210 onto articles within an associated rack assembly. In such a manner, performance of spray arm 200 may be improved.

FIG. 6 illustrates a method 600 for forming a unitary spray arm according to an exemplary embodiment of the present subject matter. Method 600 may be used to form any suitable spray arm. For example, method 600 may be used to form spray arm 200 (FIG. 3). Method 600 permits formation of various features of spray arm 200, as discussed in greater detail below. Thus, method 600 is discussed in greater detail below with reference to spray arm 200.

Method 600 includes fabricating spray arm 200 as a unitary spray arm, e.g., such that spray arm 200 is formed of a single continuous piece of plastic, metal or other suitable material. More particularly, method 600 includes manufacturing or forming spray arm 200 using an additive process, such as Fused Deposition Modeling (FDM), Selective Laser Sintering (SLS), Stereolithography (SLA), Digital Light Processing (DLP), Direct Metal Laser Sintering (DMLS), Laser Net Shape Manufacturing (LNSM), electron beam sintering and other known processes. An additive process fabricates plastic or metal components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

Accordingly, at step 610, three-dimensional information of spray arm 200 is determined. As an example, a model or prototype of spray arm 200 may be scanned to determine the three-dimensional information of spray arm 200 at step 610. As another example, a model of spray arm 200 may be constructed using a suitable CAD program to determine the three-dimensional information of spray arm 200 at step 610. At step 620, the three-dimensional information is converted into a plurality of slices that each defines a cross-sectional layer of spray arm 200. As an example, the three-dimensional information from step 610 may be divided into equal sections or segments, e.g., along the central axis A of spray arm 200 or any other suitable axis. Thus, the three-dimensional information from step 610 may be discretized at step 620, e.g., in order to provide planar cross-sectional layers of spray arm 200.

After step 620, spray arm 200 is fabricated using the additive process, or more specifically each layer is successively formed at step 630, e.g., by fusing or polymerizing a plastic using laser energy or heat. The layers may have any suitable size. For example, each layer may have a size between about five ten-thousandths of an inch and about one thousandths of an inch. Spray arm 200 may be fabricated using any suitable additive manufacturing machine as step 630. For example, any suitable laser sintering machine, inkjet printer or laserjet printer may be used at step 630.

Utilizing method 600, spray arm 200 may have fewer components and/or joints than known spray arms. Specifically, spray arm 200 may require fewer components because spray arm 200 may be a single piece of continuous plastic or metal, e.g., rather than multiple pieces of plastic or metal joined or connected together. In addition, method 600 may permit formation of channels 220 within spray arm 200 with different sizes or cross-sectional areas. As a result, spray arm 200 may provide improved wash fluid spray and cleaning of articles with wash fluid from outlets 210. Also, spray arm 200 may be less prone to leaks and/or be stronger when formed with method 600.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance, comprising:
a tub defining a wash chamber;
a rack assembly disposed within the wash chamber of the tub, the rack assembly configured for supporting articles for washing within the wash chamber of the tub;
a spray assembly with a unitary spray arm positioned within the wash chamber of the tub, the unitary spray arm of the spray assembly configured for rotation about a central axis of the spray assembly, the unitary spray arm of the spray assembly defining a plurality of outlets, at least one outlet of the plurality of outlets positioned adjacent an end portion of the unitary spray arm, the unitary spray arm of the spray assembly also defining a plurality of channels within the unitary spray arm, each channel of the plurality of channels extending to at least one of the plurality of outlets in order to direct wash fluid to at least one of the plurality of outlets, a first channel of the plurality of channels having a first cross-sectional area, a second channel of the plurality of channels having a second cross-sectional area, the first cross-sectional area being different than the second cross-sectional area.

2. The dishwasher appliance of claim 1, wherein the unitary spray arm is constructed of a single, continuous piece of material.

3. The dishwasher appliance of claim 2, wherein the single, continuous piece of material comprises a plastic.

4. The dishwasher appliance of claim 1, wherein each channel of the plurality of channels extends from a central portion of the unitary spray arm to at least one of the plurality of outlets within the unitary spray arm.

5. The dishwasher appliance of claim 4, wherein the channels of the plurality of channels are separate from one another within the unitary spray arm.

6. The dishwasher appliance of claim 1, wherein the outlets of the plurality of outlets are distributed along a length of the unitary spray arm between a central portion of the unitary spray arm and the end portion of the unitary spray arm.

7. The dishwasher appliance of claim 1, wherein the first channel of the plurality of channels extends to a first one of the plurality of outlets, the second channel of the plurality of channels extending to a second one of the plurality of outlets, the first one of the plurality of outlets positioned closer to the end portion of the unitary spray arm than the second one of the plurality of outlets, the first cross-sectional area being larger than the second cross-sectional area.

8. The dishwasher appliance of claim 1, wherein a cross-sectional of at least one channel of the plurality of channels varies along a length of the at least one channel.

9. The dishwasher appliance of claim 1, wherein a cross-sectional of at least one channel of the plurality of channels is constant along a length of the at least one channel.

10. The dishwasher appliance of claim 1, wherein a cross-sectional area of each channel of the plurality of channels is selected to provide a desired spray pattern from the unitary spray arm toward the rack assembly.

11. A method for forming a unitary spray arm for a dishwasher appliance, comprising:
establishing three-dimensional information of the unitary spray arm;
converting the three-dimensional information of the unitary spray arm from said step of establishing into a plurality of slices, each slice of the plurality of slices defining a respective cross-sectional layer of the unitary spray arm; and
successively forming each cross-sectional layer of the unitary spray arm with an additive process;
wherein, after said step of successively forming, the unitary spray arm: (1) defines a plurality of outlets with at least one outlet of the plurality of outlets positioned adjacent an end portion of the unitary spray arm; (2) defines a plurality of channels within the unitary spray arm with each channel of the plurality of channels extending to at least one of the plurality of outlets, a first channel of the plurality of channels having a first cross-sectional area, a second channel of the plurality of channels having a second cross-sectional area, and the first cross-sectional area being different than the second cross-sectional area.

12. The method of claim 11, wherein the additive process comprises at least one of fused deposition modeling, selective laser sintering, stereolithography, and digital light processing.

13. The method of claim 11, wherein the unitary spray arm is a single, continuous piece of material after said step of successively forming.

14. The method of claim 13, wherein the single, continuous piece of material comprises a plastic.

15. The method of claim 11, wherein each channel of the plurality of channels extends from a central portion of the unitary spray arm to at least one of the plurality of outlets within the unitary spray arm after said step of successively forming.

16. The method of claim 14, wherein the channels of the plurality of channels are separate from one another within the unitary spray arm after said step of successively forming.

17. The method of claim 11, wherein the first channel of the plurality of channels extends to a first one of the plurality of outlets after said step of successively forming, the second channel of the plurality of channels extending to a second one of the plurality of outlets after said step of successively forming, the first one of the plurality of outlets positioned closer to the end portion of the unitary spray arm than the second one of the plurality of outlets, the first cross-sectional area being larger than the second cross-sectional area.

18. The method of claim 11, wherein a cross-sectional of at least one channel of the plurality of channels varies along a length of the at least one channel after said step of successively forming.

19. The method of claim 11, wherein a cross-sectional of at least one channel of the plurality of channels is constant along a length of the at least one channel after said step of successively forming.

20. The method of claim 11, wherein said step of establishing three-dimensional information of the unitary spray arm comprises selecting a cross-sectional area of each channel of the plurality of channels in order to provide a desired spray pattern from the unitary spray arm.
